(19) United States
(12) Patent Application Publication
(10) Pub. No.: US 2004/0258440 A1
(43) Pub. Date: Dec. 23, 2004

(54) Fusers and intermediate transfer members

(76) Inventor: Ilan Romem, Ramat Hasharon (IL)

Correspondence Address: William H Dippert, Reed Smith, 599 Lexington Avenue, 29th Floor, New York, NY, 10022-7650, US

(21) Appl. No.: 10/493,851

(22) PCT Filed: Oct. 30, 2001
(86) PCT No.: PCT/IL01/01008

(51) Int. Cl. G03G 15/20

(52) U.S. Cl. 399/330

(57) ABSTRACT

A drum (10) usable as an intermediate transfer member or fuser in a copier or printer, comprising: an outer cylinder (16) for contact with a toner image; an inner cylinder (18); and a quantity of liquid (12) between and in contact with said inner and outer cylinders; wherein the inner cylinder is stationary or rotatable at one or both of a different rotation direction and a different rotation rate from that of the outer cylinder.

### FIELD OF THE INVENTION

The present invention is related to the field of printers and copiers and more particularly to printers or copiers that utilize fusers, intermediate transfer members and/or elements that function as both fusers and intermediate transfer members.

### BACKGROUND OF THE INVENTION

Printers and copiers are well known. Modern copiers that utilize powder or liquid toners comprising toner particles to form visible images generally form a latent electrostatic image on an image forming surface (such as a photoreceptor), develop the image utilizing a toner (such as the aforementioned powder or liquid toners) to form a developed image and transfer the developed image to a final substrate. The transfer may be direct, i.e., the image is transferred directly to the final substrate from the image forming surface, or indirect, i.e., the image is transferred to the final substrate via one or more intermediate transfer members.

In general, the image on the final substrate must be fused and fixed to the substrate. This step is achieved in most copiers and printers by heating the toner image on the substrate. In some copiers and printers the fusing and fixing of the image is performed simultaneously with the transfer of the image to the substrate. This is achieved by utilizing a heated intermediate transfer member to perform the transfer and by pressing the intermediate transfer member against the final substrate. This combination of heat and pressure softens the toner particles and fixes them to the substrate. In other copiers and printers, the image is first transferred to the final substrate, and then fused by a separate fuser.

In several prior art devices, a drum used as an intermediate transfer member or fuser contains water or another fluid in its interior. These include devices described in PCT Publication WO 00/31593, EP 0 772 100 A2, JP Publication 08320625, U.S. Pat. No. 4,172,976, and PCT Application PCT/IL00/00652 filed Oct. 13, 2000, the disclosures of all of which are incorporated herein by reference. There are two reasons for including fluid inside the drum. The first reason is that the fluid can keep the outer surface of the drum at a uniform temperature. This is important for obtaining good image quality, and especially for avoiding “short-term memory” effects, in which an image can be affected by the previous image. Such short-term memory effects are believed to be caused by lower surface temperatures in regions where the drum previously had liquid toner, which cools the surface locally when it evaporates. Having fluid inside the drum has been found to practically eliminate short-term memory. The second reason for using fluid, described in WO 00/31593, is that when the fluid gets hot, the vapor pressure of the fluid inside the drum can support a thin membrane, allowing it to conform slightly to the surface of the substrate that it is in contact with, when transferring images or fixing images. That could also be accomplished by maintaining air under pressure inside the drum, or by including a layer of compliant spongy material underlying the outer surface of a drum whose interior is rigid. But maintaining air under pressure inside the drum would require a pumping system, and a spongy layer can easily become damaged, and thermally insulates the surface from the source of heat inside the drum. Another advantage of using a thin membrane supported by gas pressure is that the heat capacity on transfer is low, so the image cools and hardens during transfer.

A disadvantage of using fluid inside the drum is that it takes longer to heat the drum up to its operating temperature when the copier or printer is first turned on. In order to minimize this problem, WO 00/31593 describes an inner cylinder inside the drum, concentric with the outer surface. The fluid is confined to the relatively small volume between the inner and outer cylinders. The relatively small volume of fluid does not take as long to heat up, but it is still effective at keeping the outer surface of the drum at a uniform temperature. With this configuration, it may be convenient to heat the fluid by first heating the inner cylinder, for example resistively or by a halogen lamp located inside it, and using the inner cylinder to heat the fluid. Alternatively, the inner cylinder could be made of quartz or some other transparent material, and a lamp inside the inner cylinder could directly heat the fluid and/or the outer cylinder radiatively. Alternatively, a heating element of some other kind could directly heat the fluid.

### SUMMARY OF INVENTION

Whether the fluid is heated by the inner cylinder or by some other means, it is desirable to induce turbulence as the drum rotates. That is to say, it is desirable for the fluid to exhibit some vortex motion, even if it does not exhibit fully developed turbulence. Such vortex motion will increase the heat transfer rate for a given temperature differential across the fluid, since heat will be transferred by convection as well as by conduction. Since the required heat transfer rate is fixed by conduction of heat from the outer surface of the drum to the substrate that it is in contact with, this means that the temperature differential across the fluid can be smaller if the fluid flow is non-laminar. Keeping the fluid flow non-laminar also means that the outer surface of the drum will be heated more uniformly, even if the fluid is heated very locally.

For a given gap between the inner and outer cylinders, vortices will develop at a lower rotation rate of the drum (i.e. the outer cylinder) if the inner cylinder is rotating in a direction opposite to the outer cylinder, rather than rotating in the same direction. Further, for a given speed of rotation of the outer cylinder, counter-rotating the inner cylinder will increase any turbulence that is present. In an embodiment of the invention, the inner cylinder rotates in a direction opposite to the outer cylinder, in order to induce or intensify turbulence.

In an embodiment of the invention, the fusing/intermediate transfer drum comprises a hollow outer cylinder, an inner cylinder within and coaxial with the outer cylinder, a heater, fluid located in the space between the inner and outer cylinders, and end caps on each end of the outer cylinder to keep the fluid from leaking out. Bearings on each end of the inner cylinder are mounted in the end caps, supporting the inner cylinder while allowing it to rotate with respect to the outer cylinder.

In some embodiments of the invention, the bearing on one end is located entirely inside the outer cylinder, but the bearing on the other end consists of a shaft which goes through the end cap, surrounded by a rotating seal to keep the fluid from leaking out. On the outside of that end cap, the shaft is surrounded by a cylindrical housing, coaxial with the shaft but with some space between them, and fixed to the end cap. A roller is positioned on one side of the shaft, between the shaft and the housing. The axis of the roller is fixed in place by attaching it to the frame of the copier or printer, but the roller is free to rotate. There is sufficient friction between the roller and the inner surface of the housing, and between the roller and the outer surface of the shaft, that the roller surface will not slide with respect to these surfaces. Alternatively, there are teeth on the roller and on these surfaces to prevent them from sliding. When the outer cylinder rotates, the housing will rotate with it, and this will cause the roller to rotate, which in turn will cause the shaft and the inner cylinder to rotate in the opposite direction.

In other embodiments, both bearings of the inner cylinder are located entirely within the end caps of the outer cylinder. The shaft, housing and roller are also located within the outer cylinder. In some of these embodiments, the axis of the roller is held in place magnetically, by a holder located near it but on the other side of the end cap. However, it is free to roll. In others of these embodiments, the roller is heavy enough and free enough to roll that it always remains at the bottom of the housing as the drum turns.

In other embodiments, there is no roller, and the shaft of the inner cylinder extends outside one of the end caps, and it is caused to rotate in one direction by one motor, while another motor causes the outer cylinder to rotate in the other direction. Alternatively, both cylinders could be driven by the same motor, using belts or gears.

In other embodiments, there is no roller, and both bearings are located entirely within the end-caps of the outer cylinder. A motor compromising a rotor and a stator is used to drive the inner cylinder. The rotor is mounted on the inner cylinder close to one of the end caps, and the stator is located just outside that end cap. Alternatively, a disk, located just outside one of the end caps, could be made to rotate by a motor. The disk could be coupled magnetically to the inner cylinder, causing it to rotate at the same rate. In both these cases, another motor drives the outer cylinder in the opposite direction.

In embodiments where there is no roller, it is possible to make the inner cylinder rotate in the same direction but at a different rate than the outer cylinder, or to make the inner cylinder remain stationary while the outer cylinder rotates. In these situations, the fluid will still become turbulent at a lower rotation rate of the outer cylinder, than it would if the inner and outer cylinders were rotating in the same direction at the same rate.

There is thus provided, in accordance with an embodiment of the invention, a drum usable as an intermediate transfer member or fuser in a copier or printer, comprising:

an outer cylinder for contact with a toner image;

an inner cylinder; and

a quantity of liquid between and in contact with said inner and outer cylinders;

wherein the inner cylinder is stationary or rotatable at one or both of a different rotation direction and a different rotation rate from that of the outer cylinder.

In an embodiment of the invention, the different rotation rate or different rotation direction of the inner and outer cylinders induces or intensifies turbulence in the liquid.

In an embodiment of the invention, the turbulence in the liquid leads to increased heat transport between the inner and outer cylinders.

In an embodiment of the invention, the turbulence in the liquid leads to more uniform heating of the outer cylinder.

Optionally, a roller, operatively associated with the inner and outer cylinders operates to cause the inner cylinder to rotate in a direction opposite to the direction of rotation of the outer cylinder. Optionally, the roller is located in the interior of the drum. Alternatively, the roller may be located exterior to the drum.

Optionally, the roller axis is held substantially at a constant location, while the roller is free to rotate about its axis. Optionally, the roller axis is anchored in place. Alternatively, the roller axis may be held in place magnetically. Alternatively, the roller axis may be held in place by gravity.

In an embodiment of the invention, a first motor drives the inner cylinder and a second motor drives the outer cylinder. Optionally, the inner cylinder has a drive shaft that extends to the exterior of the drum. Alternatively, the inner cylinder could be magnetically coupled to a drive shaft that is located outside the drum. Alternatively, the motor driving the inner cylinder could be have a rotor located inside the drum, and a stator located outside the drum. Optionally, the motor driving the inner cylinder is a permanent magnet motor. Alternatively, the motor driving the inner cylinder may be an induction motor, or any other kind of motor known to the art.

In an embodiment of the invention, a single motor drives both the inner and outer cylinders. Optionally, the inner cylinder has a drive shaft that extends to the exterior of the drum. Alternatively, the inner cylinder could be magnetically coupled to a drive shaft that is located outside the drum.

Optionally, the single motor directly drives the outer cylinder, and drives the inner cylinder by means of gears. Alternatively, the single motor could drive both cylinders by means of gears, or could drive one or more cylinders by means of belts.

In an embodiment of the invention, a single motor drives the outer cylinder, and the inner cylinder substantially does not rotate. Optionally, the inner cylinder is prevented from rotating by a shaft which extends to the outside of the drum. Alternatively, the inner cylinder could be prevented from rotating by means of magnetic force. Alternatively, the inner cylinder could be prevented from rotating by means of gravity.

In an embodiment of the invention, the outer cylinder has a thin wall. Optionally, the wall of the outer cylinder is supported by gas pressure.

In an embodiment of the invention, there is a heater within the inner cylinder.

### BRIEF DESCRIPTION OF THE DRAWINGS

Exemplary embodiments of the invention are described in the following sections with reference to the drawings. The drawings are generally not to scale and the same or similar reference numbers are used for the same or related features on different drawings.

FIG. 1 is a schematic axial view of a drum with counter-rotating inner cylinder in accordance with an embodiment of the invention;

FIGS. 2A, 2B, and 2C are side views of two different embodiments of the drum of FIG. 1;

FIG. 3 is a side view of an alternative embodiment of a drum, in accordance with an embodiment of the invention;

FIGS. 4A is a side view, and 4B and 4C are perspective views, of still other embodiments of a drum;

FIG. 5 is a side view of another embodiment of a drum; and

FIG. 6 is a side view of the drum, showing a different method of coupling to the inner cylinder, in accordance with an embodiment of the invention.

### DETAILED DESCRIPTION OF EXEMPLARY EMBODIMENTS

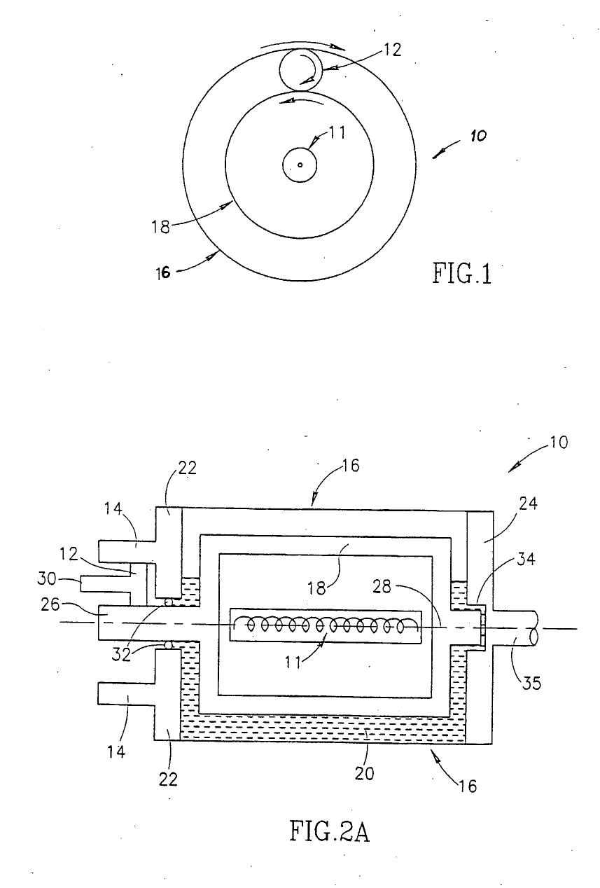

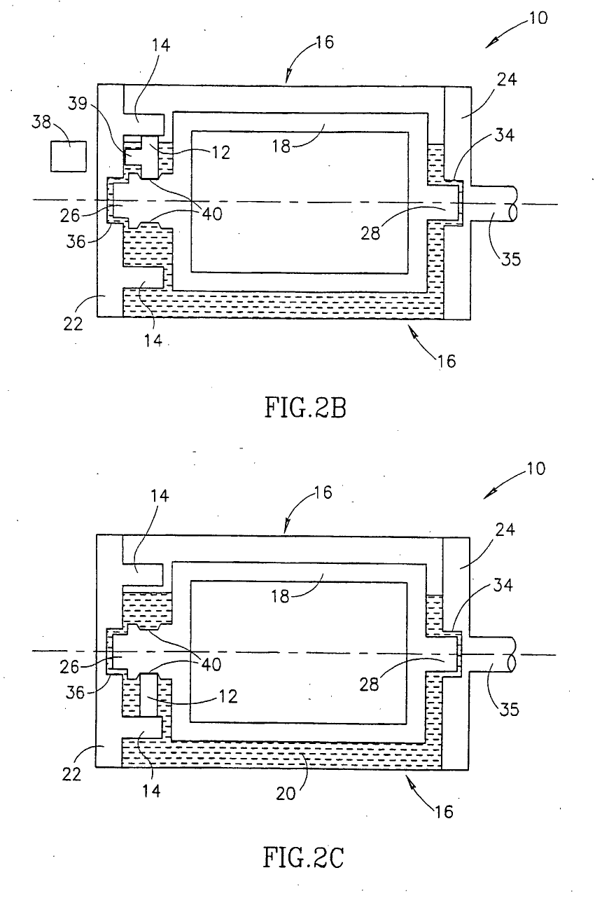

FIG. 1 is a schematic axial view of a drum 10, in accordance with an embodiment of the invention. Drum 10 comprises a heating element 11, a roller 12, in contact with both a housing 14 (FIG. 2) of an outer cylinder 16, and an inner cylinder 18. Heating element 11 could be a halogen lamp located on the axis of the inner cylinder, as suggested in FIG. 1, or it could be a resistive heater in the wall of the inner cylinder, or any other kind of heater known to the art. Although free to rotate on its axis, the axis of the roller is fixed in place. This forces the inner cylinder to rotate at the same speed but in the opposite direction as the housing. In some embodiments, the roller is in contact not with inner cylinder 18, but with a shaft that is connected to inner cylinder 18. However, the principle of operation is the same as shown in FIG. 1.

FIGS. 2A, 2B and 2C show side views of the drum 10 for three different embodiments that use a roller to drive counter-rotation of the outer and inner cylinders. In all these embodiments, there is fluid 20 filling up at least part of the space between outer cylinder 16 and inner cylinder 18, as in the prior art described, for example, in PCT Application PCT/IL00/00652 filed Oct. 13, 2000. There are two end caps, 22 and 24, at the ends of outer cylinder 16, which prevent the fluid from leaking out. Optionally, end caps 22 and 24 could also allow air or another gas between the outer and inner cylinders to remain at an elevated pressure. Optionally, the wall of outer cylinder 16 could consist of a thin membrane, supported by such gas pressure. In FIG. 2A, roller 12 is located outside end cap 22, and housing 14 is attached to the outside of end cap 22. The inner cylinder has two shafts 26 and 28. Shaft 26 extends beyond end cap 22, and roller 12 stays in contact with the outside of shaft 26 and the inner surface of housing 14. Friction or teeth prevent the roller from sliding with respect to these surfaces, but the rolleris free to rotate about its axis 30. A rotating seal 32 surrounding shaft 26 keeps the fluid from leaking out of the interior of the drum, and keeps a higher pressure inside the drum in the case of a drum whose surface compliance is maintained by gas pressure. Roller axis 30 is held in place simply by attaching it to the frame of the copier or printer. In FIG. 2A, shaft 28, which is the other shaft of inner cylinder 18, is shown mounted on a bearing 34 against the inside of end cap 24. However, shaft 28 could also extend outside end cap 24 with its own rotating seal, similar to rotating seal 32. Any method known to the art could be used to rotate outer cylinder 16. For example, FIG. 2A shows a shaft 35 attached to end cap 24, which can be attached to a motor (not shown in FIG. 2A) which causes it to rotate.

FIG. 2A shows heating element 11 in the interior of inner cylinder 18, where it could heat inner cylinder 18 radiantly. Optionally, inner cylinder 18 could be made of quartz or another transparent material, and heating element 11 could directly heat fluid 20 and/or outer cylinder 16 radiatively. Optionally, heating element 11 could instead use resistive heating, or any other method of heating known to the art, and it could be located in the wall of inner cylinder 18 rather than in the interior of inner cylinder 18. It could also be located in the fluid. Electric power could be supplied to heating element 11 from outside the drum, by means of slip rings, or inductively, or by any other means known to the art. In some embodiments, where inner cylinder 18 is not rotating and is connected to a shaft that extends outside the drum, electric power could be supplied to heating element 11 by a direct electrical connection. Heating element 11 is present also in the embodiments shown in all of the following drawings, but it is not shown in those drawings.

In FIG. 2B, roller 12 is located just inside end cap 22. Inner cylinder 18 is located entirely inside drum 10, rotating freely on bearings 34 and 36 that are located inside end caps 24 and 22 respectively, so there is no need for a rotating seal. Housing 14 is attached to the inside of end cap 22, and roller 12 is in contact with the inner surface of housing 14, and the outer surface of inner cylinder 18. Roller 12 is made at least partly of iron or some other magnetic material. A holder 38, consisting at least partly of a magnet, is located just outside end cap 22, close to roller 12, and keeps the axis of roller 12 from moving with outer cylinder 16 and housing 14 as they rotate. FIG. 2B shows a track 40 on the outer surface of inner cylinder 18, which keeps roller 12 from moving axially, preventing roller 12 from moving up to end cap 22 and rubbing against it, which might impede its rotating, and also preventing roller 12 from accidentally moving away from the magnet in holder 38 and consequently ceasing to be held in place by the magnet, or moving past the end of housing 14 and losing contact with it. This could also be accomplished by having a track on the inner surface of housing 14, or two tracks, one on each surface. Other methods could also be used to keep roller 12 from moving axially. For example, roller axis 30 could extend axially to both end cap 22 and end cap 24, and slide around races in the end caps as outer cylinder 16 (together with end caps 22 and 24) rotates. Whatever mechanism is used to prevent roller 12 from moving axially, it must not seriously impede roller 12 from rotating freely, and it must not seriously impede outer cylinder 16 and inner cylinder 18 from rotating freely.

Instead of making roller 12 out of iron or another soft magnetic material, it could be made at least partly of a magnet, and holder 38 could be made at least partly of iron or another magnetic material. In still another embodiment, both roller 12 and the holder 38 could be made at least partly of magnets.

If the magnetic field turns out to significantly impede roller 12 from rotating about its axis, then the central part of roller 12 could consist of a roller bearing 39 made at least partly of a magnetic material, and the rest of roller 12 could be non-magnetic. The friction between roller bearing 39 and roller 12 could be low enough so that roller 12 can rotate freely even if roller bearing 39 is not rotating. Then it will not matter if the magnetic field impedes roller bearing 39 from turning.

The embodiment shown in FIG. 2C is like that in FIG. 2B, but roller 12 is not magnetic, and there is no holder. Instead, roller 12 is heavy enough, and free enough to roll, that it always remains at the lowest point on housing 14, as outer cylinder 16 rotates. The force of gravity plays the same role in keeping the roller in place that magnetic force plays in the embodiment shown in FIG. 2B. If roller 12 and holder 38 were located at the bottom of housing 14 in the embodiment shown in FIG. 2B, then both gravity and magnetic force would contribute to keeping roller 12 in place as outer cylinder 16 rotates.

In FIGS. 2B and 2C, as in FIG. 2A, any means could be used to rotate outer cylinder 16. For example, any kind of motor could cause shaft 35 to rotate, thereby causing the outer cylinder to rotate.

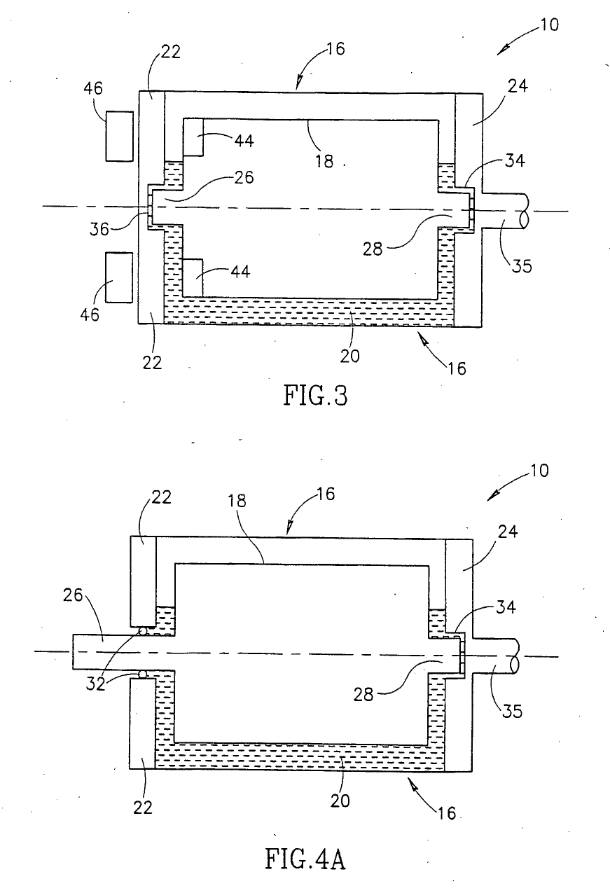

Another embodiment of the invention is shown in FIG. 3. In this embodiment, there is no roller. Instead, a separate motor 42, comprising a rotor 44 and a stator 46, turns inner cylinder 18. As in FIG. 2B, inner cylinder 18 is located entirely inside drum 10, with bearings 34 and 36 on the inside of end caps 24 and 22 respectively, so there is no need for a rotating seal. Rotor 42 could consist of a set of magnets spaced at intervals azimuthally around inner cylinder 18, near end cap 22. Stator 46 consists of a set of coils located just outside end cap 22. By applying AC current to the coils of stator 46 with appropriate phase, or by applying DC current with a commutator, stator 46 will interact magnetically with rotor 44, causing inner cylinder 18 to rotate. Any other standard or nonstandard type of rotor and stator could also be used to make inner cylinder 18 rotate. For example, instead of using magnets for rotor 44, a “squirrel cage” could be used, with AC current induced in it inductively by stator 46, as is done in an induction motor.

As in FIGS. 2A, 2B, and 2C, any means can be used to make outer cylinder 16 rotate. For example, any kind of motor can be used to rotate shaft 35, thereby causing outer cylinder 16 to rotate.

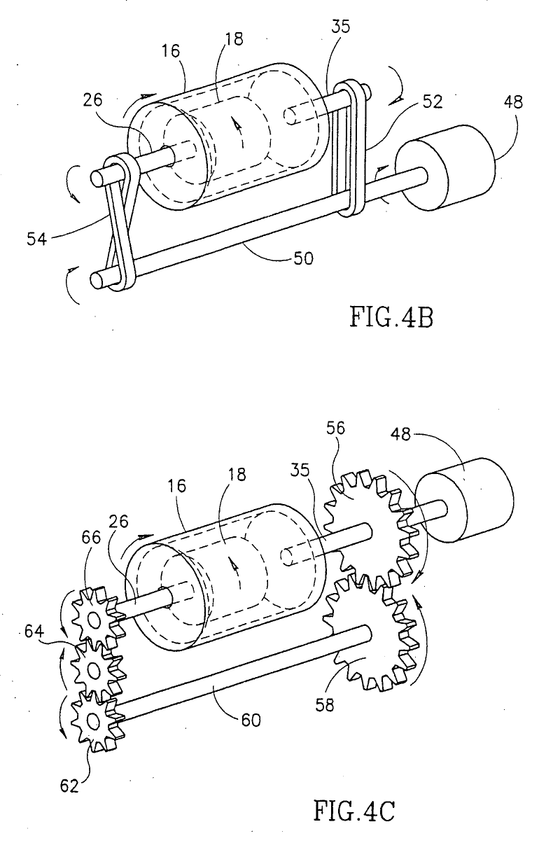

Another embodiment of the invention is shown in FIG. 4A. Shaft 26 extends past end cap 22, as in FIG. 2A, and rotating seal 32 keeps fluid 20 inside drum 10, and maintains the gas pressure there, if there is any gas pressure. Shaft 26 is then caused to rotate by any kind of motor, which causes inner cylinder 18 to rotate. Another motor causes outer cylinder 16 to rotate, for example by means of shaft 35, as in FIGS. 2A, 2B, and 3. Although this embodiment requires the use of a rotating seal, the motor driving inner cylinder 18 could be more efficient, and perhaps more reliable and cheaper, than motor 42 in the embodiment shown in FIG. 3, since there is no need for the rotor and the stator to be on opposite sides of end cap 22. In particular, an off-the-shelf motor could be used in this embodiment, while in the embodiment shown in FIG. 3 it might be necessary to design and manufacture a new motor. As in FIGS. 2A, 2B, 2C, and 3, any means can be used to rotate outer cylinder 16, for example another motor attached to shaft 35.

In fact, inner cylinder 18 could be driven by the same motor which drives outer cylinder 16, using mechanisms such as belts and gears. An exemplary embodiment of this method is shown in FIG. 4B. A motor 48, which can be any kind of motor known to the art, has a shaft 50 which it causes to rotate. An outer cylinder drive belt 52 in contact with shaft 50 and shaft 35 causes shaft 35 and outer cylinder 16 to rotate in the same direction as shaft 50. An inner cylinder drive belt 54, with a twist in it, is in contact with shaft 50 and shaft 26. Because it is twisted, belt 54 causes shaft 26 and inner cylinder 18 to rotate in a direction opposite to shaft 50.

FIG. 4C shows another exemplary embodiment of a method of driving inner cylinder 18 and outer cylinder 16 by the same motor. A motor 48 directly drives shaft 35. A gear 56, attached to shaft 35, meshes with a gear 58, causing gear 58 to turn in the opposite direction of gear 56 and shaft 35. Gear 58 is attached to a shaft 60, which is attached to a gear 62, causing gear 62 to turn in the opposite direction to shaft 35. Gear 62 is enmeshed with a gear 64, and gear 64 is enmeshed with a gear 66, which is attached to shaft 26. Thus shaft 26 turns in the same direction as gear 62, and in the opposite direction to shaft 35.

In other embodiments of the invention, inner cylinder 18 could be rotating in the same direction as outer cylinder 16, but at a different rate. If inner cylinder 18 and outer cylinder 16 are driven by two different motors, as in FIG. 4A, then the two motors could be rotating in the same direction at different rates. It is also possible for inner cylinder 18 and outer cylinder 16 to rotate in the same direction at different rates even if they are driven indirectly by the same motor. For example, if gear 62 in FIG. 4C were directly enmeshed with gear 66, rather than indirectly through gear 64, then gear 66 and shaft 26 would rotate in the same direction as shaft 35. But, depending on the ratios of the diameters of gears 56, 58, 62, and 66, shaft 26 could be rotating at a different rate than shaft 35.

In other embodiments of the invention, inner cylinder 18 is stationary while outer cylinder 16 is rotating. For example, if shaft 26 in FIG. 4A is attached to the frame of the copier or printer, rather than attached to a motor, then inner cylinder 18 would remain stationary while outer cylinder 16 rotates. FIG. 5 shows another embodiment of the invention in which inner cylinder 18 remains stationary while outer cylinder 16 rotates. In FIG. 5, as in FIG. 3, inner cylinder 18 is mounted on bearings 34 and 36 inside end caps 24 and 22. A weight 68, at the bottom of inner cylinder 18, keeps inner cylinder 18 from rotating when outer cylinder 16 rotates. Optionally, there could be a magnetic piece 70, made at least partly of a magnetic material, attached to inner cylinder 18, in addition to or instead of weight 68, and there could be a holder 72, made at least partly of a magnet, located outside outer cylinder 16 but near magnetic piece 70, and attached to the frame of the printer or copier. The magnetic attraction between magnetic piece 70 and holder 72 would also keep inner cylinder 18 from rotating when outer cylinder 16 rotates. Optionally, magnetic piece 70 and weight 68 could be the same piece. Optionally, magnetic piece 70 could include a magnet, and holder 72 could be made at least partly of a magnetic material. Optionally, both magnetic piece 70 and holder 72 could include magnets, oriented so as to attract each other. In any of the embodiments in which magnetic force is used to keep inner cylinder 18 from rotating, drum 10 should preferably be designed so that magnetic forces do not unduly inhibit outer cylinder 16 from rotating, and so that any magnetic materials used in outer cylinder 16 and end caps 22 and 24 do not magnetically shield magnetic piece 70 from holder 72 too much.

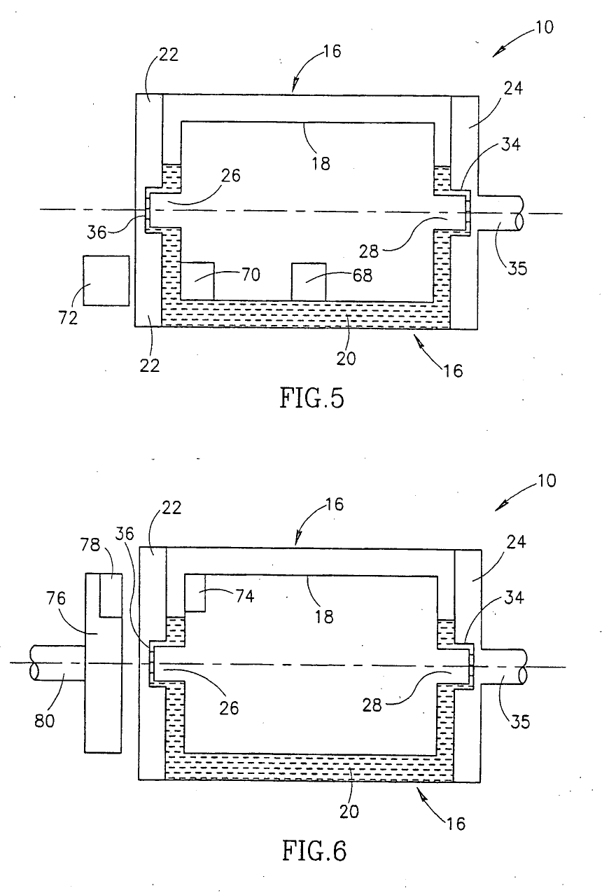

In any of the embodiments in which shaft 26 extends from inner cylinder 18 through end cap 22 to the outside (for example, the embodiments shown in FIGS. 2A, 4A and 4B), inner cylinder 18 could instead be coupled magnetically to the outside, as show in FIG. 6. Shaft 26 does not extend through end cap 22, but rests on bearing 36 inside end cap 22. At least one magnet 74 is attached to the end of inner cylinder 18 near end cap 22, and a disk 76, with at least one magnet 78, is located just outside end cap 22. Alternatively, either magnet 74 or magnet 78 could be replaced by a piece of magnetic material. When disk 76 rotates, inner cylinder 18 is made to rotate by magnetic force. Disk 76 is attached to shaft 80, which serves the same function as shaft 26 does in FIGS. 2A, 4A, and 4B.

In the claims of the present application, the verbs “comprise” and “include” and conjugates thereof mean “include but are not necessarily limited to.”

While the invention has been described with reference to certain exemplary embodiments, various modifications will be readily apparent to and may be readily accomplished by persons skilled in the art without departing from the spirit and scope of the above teachings. Furthermore, features found in one embodiment may be used in other embodiments. In some embodiments, fewer elements may be present. For example, while the invention is described with reference to a thin-walled pressure-supported drum, in some embodiments of the invention the wall of the drum may be thick enough to be self-supporting. Furthermore, while an internal heater is described, in some embodiments external heating may be used with the liquid acting to distribute the heat uniformly on the drum. Therefore, it is understood that the invention may be practiced other than as specifically described herein without departing from the scope of the following claims:

1. A drum usable as an intermediate transfer member or fuser in a copier or printer, comprising:
an outer cylinder for contact with a toner image;
an inner cylinder; and
a quantity of liquid between and in contact with said inner and outer cylinders;
wherein the outer cylinder is rotated and wherein either:
the inner cylinder is rotated and wherein the inner cylinder is rotated at one or both of a different rotation direction and a different rotation rate from that of the outer cylinder; or
the inner cylinder is stationary or rotatable at one or both of a different rotation direction and a different rotation rate from that of the outer cylinder and wherein the inner cylinder has substantially a constant radius as a function of angular position.

2. A drum according to claim 1, wherein the inner cylinder has substantially a constant radius as a function of angular position.

3. A according to claim 1 wherein the inner cylinder is stationary or rotatable at one or both of a different rotation direction and a different rotation rate from that of the outer cylinder and wherein the inner cylinder has substantially a constant radius as a function of angular position.

4. A drum according to claim 3 wherein the inner cylinder is stationary.

5. Apparatus according claim 1 wherein the different rotation of the inner and outer cylinders induces or intensifies turbulence in the liquid.

6. Apparatus according to claim 5 wherein the turbulence in the liquid leads to increased heat transport between the inner and outer cylinders.

7. Apparatus according to claim 5 wherein the turbulence in the liquid leads to more uniform heating of the outer cylinder.

8. Apparatus according to claim 1 and including a roller operatively associated with the inner and outer cylinders, operative to cause the inner cylinder to rotate in a direction opposite to the direction of rotation of the outer cylinder.

9. Apparatus according to claim 8 wherein the roller axis is held at a substantially constant location while the roller is free to rotate about its axis.

10-12. (Canceled)

13. Apparatus according to claim 8 wherein the roller is located in the interior of the drum.

14. Apparatus according claim 8 wherein the roller is located exterior to the drum.

15. Apparatus according to claim 1 and compromising a first motor that drives the inner cylinder and a second motor that drives the outer cylinder.

16-17. (Canceled)

18. Apparatus according to claim 15 wherein the motor causing the inner cylinder to rotate has a rotor that is located in the interior of the drum, and a stator located exterior to the drum.

19. Apparatus according to claim 1 and compromising a motor that drives both the inner cylinder and the outer cylinder.

20. A drum usable as an intermediate transfer member or fuser in a copier or printer, comprising:
an outer cylinder for contact with a toner image;
an inner cylinder; and
a quantity of liquid between and in contact with said inner and outer cylinders;
wherein the inner cylinder is constrained from rotation by one or more of a magnetic force or gravity.

21. Apparatus according to claim 20 wherein the inner cylinder is constrained from rotating by magnetic force.

22. Apparatus according to claim 20 wherein the inner cylinder is constrained from rotating by gravity.

23. Apparatus according to claim 4 wherein the inner cylinder is constrained from rotating by anchoring it in place.

24. Apparatus according to claim 1 wherein the inner cylinder has a shaft which extends from the interior to the exterior of the drum.

25. Apparatus according to claim 1 wherein the inner cylinder is magnetically coupled to a shaft outside the drum.

26-27. (Canceled)

28. Apparatus according to claim 1 wherein the outer cylinder has a thin wall.

29. Apparatus according to claim 28 wherein the wall of the outer cylinder is supported by gas pressure.

30. Apparatus according to claim 1 wherein there is a heater within the inner cylinder.
